(19) United States
(12) Patent Application Publication
(10) Pub. No.: US 2026/0231973 A1
(43) Pub. Date: Aug. 13, 2026

(54) BEAN GRINDING METHOD AND APPARATUS, ELECTRONIC DEVICE, AND STORAGE MEDIUM

(71) Applicant: MAXI (BEIJING) INTERNATIONAL BRAND MANAGEMENT CO., LTD., Beijing (CN)

(72) Inventors: Yu Chen, Beijing (CN); Kwok Yui Lawrence Ng, Beijing (CN)

(21) Appl. No.: 19/156,911

(22) PCT Filed: Feb. 7, 2024
(86) PCT No.: PCT/CN2024/076714

§ 371 Date: Sep. 25, 2025

(30) Foreign Application Priority Data
Feb. 17, 2023 (CN) 202310146679.4

(51) Int. Cl. A23F 5/08; A47J 42/44

(52) U.S. Cl. CPC A23F 5/08; A47J 42/44

(57) ABSTRACT

A bean grinding method and apparatus, electronic device, and storage medium are provided. The method comprises: according to a first grinding rate, determining a grinding duration corresponding to a second grinding rate; when the grinding rate of a bean grinding machine reaches the first grinding rate, according to the first grinding rate, the total ground powder weight, and a pipe residual powder weight and a kinetic energy residual powder weight corresponding to the second grinding rate, judging whether to start grinding at the second grinding rate under the current ground powder weight of a weighing sensor; if yes, grinding at the second grinding rate, and sending a stop signal to a motor after the grinding duration; otherwise, continuing grinding at the first grinding rate, and going back to judging whether to start grinding at the second grinding rate under the current ground powder weight of the weighing sensor to proceed.

### CROSS REFERENCE TO RELATED APPLICATION

The present disclosure claims the priority to the Chinese patent application with the filing No. 2023101466794 filed with the Chinese Patent Office on Feb. 17, 2023, and entitled “BEAN GRINDING METHOD AND APPARATUS, ELECTRONIC DEVICE, AND STORAGE MEDIUM”, which is incorporated herein by reference in entirety.

### TECHNICAL FIELD

The present disclosure relates to a technical field of bean grinding machines, and more specifically, to a bean grinding method and apparatus, electronic device, and storage medium.

### BACKGROUND

With improved living standards, bean grinding machines are becoming increasingly widely used. Bean grinding machines can be used to grind granular foods like coffee beans and soybeans into powder. To meet user demands for a weight of powder ground by the bean grinding machine, a weighing sensor is provided below the powder container for holding powder in the bean grinding machine. When a weighing value of the weighing sensor reaches the ground powder weight required by a user, the CPU sends a stop signal to a motor of the bean grinding machine, causing the bean grinding machine to stop grinding.

However, when the weighing value of the weighing sensor reaches the ground powder weight required by the user, a residual powder in a powder collection pipe of the bean grinding machine does not fall into the powder container, the motor does not stop immediately after receiving the stop signal, and it continues to grind by the residual kinetic energy, causing the actual ground powder weight of the bean grinding machine to exceed the ground powder weight required by the user.

### SUMMARY

In view of this, the purpose of the present disclosure is to provide a bean grinding method and apparatus, electronic device, and storage medium, which can enable a bean grinding machine to grind beans, and the actual ground powder weight of the bean grinding machine is equal to the total ground powder weight required by the user.

In a first aspect, embodiments of the present disclosure provide a bean grinding method, including:
acquiring a first grinding rate and a total ground powder weight set by a user;
determining, according to the first grinding rate a grinding duration corresponding to a second grinding rate; the second grinding rate is a preset known grinding rate corresponding to a pipe residual powder weight and a kinetic energy residual powder weight;
judging, when a grinding rate of a bean grinding machine reaches the first grinding rate, whether to start grinding at the second grinding rate under a current ground powder weight of a weighing sensor according to the first grinding rate, the total ground powder weight, and the pipe residual powder weight and the kinetic energy residual powder weight corresponding to the second grinding rate; and
grinding at the second grinding rate if grinding is to be started at the second grinding rate, and sending a stop signal to a motor after the grinding duration;
otherwise, continuing grinding at the first grinding rate, and going back to judging whether to start grinding at the second grinding rate under a current ground powder weight of a weighing sensor to proceed.

In one possible embodiment, judging whether to start grinding at the second grinding rate under a current ground powder weight of a weighing sensor includes:
determining a target ground powder weight according to the first grinding rate, the total ground powder weight, and the pipe residual powder weight and the kinetic energy residual powder weight; and
judging whether to start grinding at the second grinding rate by comparing the target ground powder weight with a current ground powder weight.

In one possible embodiment, judging whether to start grinding at the second grinding rate includes:
starting grinding at the second grinding rate if the target ground powder weight is the same as the current ground powder weight.

In one possible embodiment, determining a target ground powder weight includes:
determining an initial ground powder weight after grinding at the first grinding rate for a preset duration;
calculating a sum of the initial ground powder weight, the pipe residual powder weight, and the kinetic energy residual powder weight; and
subtracting the sum from the total ground powder weight to obtain the target ground powder weight.

In one possible embodiment, determining a grinding duration corresponding to a second grinding rate includes:
determining a difference between the first grinding rate and the second grinding rate; and
determining the grinding duration according to the difference and the second grinding rate.

In one possible embodiment, before judging a grinding duration corresponding to a second grinding rate, the bean grinding method further comprises:
judging whether the first grinding rate and the second grinding rate are the same;
setting the grinding duration to zero and going back to judging whether to start grinding at the second grinding rate under a current ground powder weight of a weighing sensor to proceed, if the first grinding rate and the second grinding rate are the same; and
going back to determining a grinding duration corresponding to a second grinding rate to proceed, if the first grinding rate and the second grinding rate are different.

In a second aspect, embodiments of the present disclosure further provide a bean grinding apparatus, including:
an acquisition module, configured to acquire a first grinding rate and a total ground powder weight set by a user;
a determination module, configured to determine, according to the first grinding rate, a grinding duration corresponding to a second grinding rate; the second grinding rate is a preset known grinding rate corresponding to a pipe residual powder weight and a kinetic energy residual powder weight;
a judgment module, configured to judge, when a grinding rate of a bean grinding machine reaches the first grinding rate, whether to start grinding at the second grinding rate under a current ground powder weight of a weighing sensor according to the first grinding rate, the total ground powder weight, and the pipe residual powder weight and the kinetic energy residual powder weight corresponding to the second grinding rate; and
a grinding module, configured to grind at the second grinding rate, if grinding is to be started at the second grinding rate;
a sending module, configured to send a stop signal to a motor after the grinding duration;
a jumping module, configured to otherwise continue grinding at the first grinding rate, and go back to judging whether to start grinding at the second grinding rate under a current ground powder weight of a weighing sensor to proceed.

In one possible embodiment, the judgment module is specifically configured to:
determine a target ground powder weight according to the first grinding rate, the total ground powder weight, and the pipe residual powder weight and the kinetic energy residual powder weight; and judge whether to start grinding at the second grinding rate by comparing the target ground powder weight with a current ground powder weight.

In one possible embodiment, the judgment module is further configured to start grinding at the second grinding rate if the target ground powder weight is the same as the current ground powder weight.

In one possible embodiment, the judgment module is further configured to:
determine the initial ground powder weight after grinding at the first grinding rate for a preset duration;
calculate a sum of the initial ground powder weight, the pipe residual powder weight, and the kinetic energy residual powder weight; and
subtract the sum from the total ground powder weight to obtain the target ground powder weight.

In one possible embodiment, the determination module is specifically configured to determine a difference between the first grinding rate and the second grinding rate; and determine the grinding duration according to the difference and the second grinding rate.

In one possible embodiment, the bean grinding apparatus further includes: a setting module;
a judgment module, further configured to judge whether the first grinding rate and the second grinding rate are the same;
a setting module, configured to set the grinding duration to zero if the first grinding rate and the second grinding rate are the same;
a jumping module, further configured to go back to judging whether to start grinding at the second grinding rate under the current ground powder weight of the weighing sensor to proceed;
the jumping module is further configured to go back to determine the grinding duration corresponding to the second grinding rate to proceed, if the first grinding rate and the second grinding rate are different.

In a third aspect, embodiments of the present disclosure further provide an electronic device including: a processor, a storage medium, and a bus, wherein the storage medium stores machine-readable instructions executable by the processor; and when the electronic device is in operation, the processor and the storage medium communicate via the bus, and the processor executes the machine-readable instructions to perform the steps of any of the bean grinding methods according to the first aspect.

In a fourth aspect, embodiments of the present disclosure further provide a computer-readable storage medium, storing a computer program thereon, wherein the computer program, when executed by a processor, performs the steps of any of the bean grinding methods according to the first aspect.

Embodiments of the present disclosure provide a bean grinding method and apparatus, electronic device, and storage medium. The bean grinding method includes: acquiring a first grinding rate and a total ground powder weight set by a user; determining a grinding duration corresponding to a second grinding rate according to the first grinding rate; the second grinding rate is a preset known grinding rate corresponding to a pipe residual powder weight and a kinetic energy residual powder weight; when a grinding rate of a bean grinding machine reaches the first grinding rate, judging whether to start grinding at the second grinding rate under a current ground powder weight of a weighing sensor according to the first grinding rate, the total ground powder weight, and the pipe residual powder weight and the kinetic energy residual powder weight corresponding to the second grinding rate; if grinding is to be started at the second grinding rate, grinding at the second grinding rate, and sending a stop signal to a motor after the grinding duration; otherwise, continuing t grinding at the first grinding rate, and going back to determining whether to start grinding at the second grinding rate under the current ground powder weight of the weighing sensor to proceed. In the present disclosure, when the grinding rate of the bean grinding machine reaches the first grinding rate, it is judged that whether to start grinding at the second grinding rate under the current ground powder weight of the weighing sensor; if grinding is to be started at the second grinding rate, grinding is performed at the second grinding rate, and the stop signal is sent to the motor after the grinding duration; otherwise, it continues to determine whether to start grinding at the second grinding rate. The present disclosure enables the bean grinding machine to grind beans, and the actual ground powder weight of the bean grinding machine is equal to the total ground powder weight required by the user.

### BRIEF DESCRIPTION OF DRAWINGS

To more clearly illustrate the technical solutions of the embodiments of the present disclosure, the following briefly describes the drawings used in these embodiments. It should be understood that the following drawings illustrate only certain embodiments of the present disclosure and should not be construed as limiting the scope of the present disclosure. For those ordinarily skilled in the art, other related drawings can be obtained based on these drawings without creative work.

FIG. 1 shows a flow chart of a bean grinding method provided in an embodiment of the present disclosure;

FIG. 2 shows a flow chart of another bean grinding method provided in an embodiment of the present disclosure;

FIG. 3 shows a schematic structural diagram of a bean grinding apparatus provided in an embodiment of the present disclosure; and

FIG. 4 shows a schematic structural diagram of an electronic device provided in an embodiment of the present disclosure.

### DETAILED DESCRIPTION OF EMBODIMENTS

To further clarify the objectives, technical solutions, and advantages of the embodiments of the present disclosure, the technical solutions in the embodiments of the present disclosure will be described clearly and completely in combination with the drawings in the embodiments of the present disclosure below. It should be understood that the drawings in the present disclosure are for illustrative and descriptive purposes only and are not intended to limit the scope of protection of the present disclosure. Furthermore, it should be understood that the schematic drawings are not drawn to scale. The flowcharts used in the present disclosure illustrate operations implemented according to some embodiments of the present disclosure. It should be understood that the operations in the flowcharts may be implemented out of sequence, and steps that do not have a logical contextual relationship may be reversed or performed simultaneously. Furthermore, those skilled in the art, guided by the contents of the present disclosure, may add one or more additional operations to the flowcharts or remove one or more operations from the flowcharts.

In addition, the described embodiments are merely some of, and not all of the embodiments of the present disclosure. The components of the embodiments of the present disclosure, generally described and illustrated in the drawings herein, may be arranged and designed in a variety of different configurations. Therefore, the following detailed description of the embodiments of the present disclosure, as provided in the drawings, is not intended to limit the claimed scope of the present disclosure, but rather merely represents selected embodiments of the present disclosure. All other embodiments derived by those skilled in the art based on the embodiments of the present disclosure without inventive effort are within the scope of protection of the present disclosure.

To enable those skilled in the art to utilize the present disclosure, the following embodiments are provided in combination with the specific application scenario of “bean grinding machine technical field”. Those skilled in the art will appreciate that the general principles defined herein can be applied to other embodiments and disclosure scenarios without departing from the spirit and scope of the present disclosure. Although the present disclosure primarily focuses on the “bean grinding machine technical field”, it should be understood that this is merely an exemplary embodiment.

It should be noted that the term “including” is used in the embodiments of the present disclosure to indicate the presence of subsequently stated features, but does not preclude the addition of other features.

The following describes in detail a bean grinding method provided in an embodiment of the present disclosure.

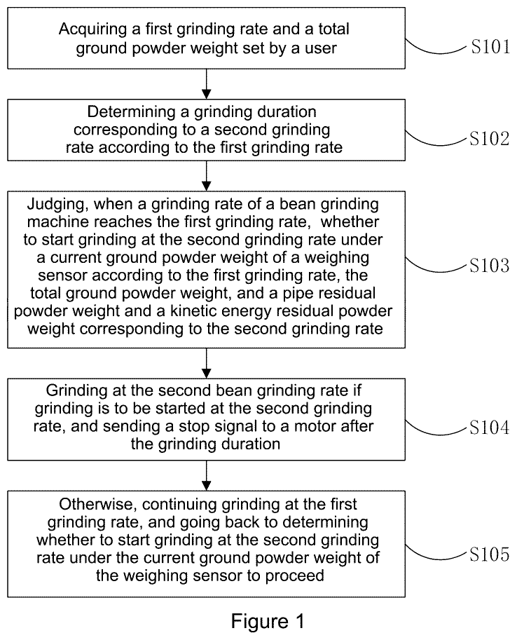

FIG. 1 shows a flow chart of a bean grinding method provided in an embodiment of the present disclosure. The specific execution process of this bean grinding method is as follows.
S101. acquiring a first grinding rate and a total ground powder weight set by a user.
S102. determining a grinding duration corresponding to a second grinding rate according to the first grinding rate.
S103. when a grinding rate of a bean grinding machine reaches the first grinding rate, judging whether to start grinding at the second grinding rate under a current ground powder weight of a weighing sensor according to the first grinding rate, the total ground powder weight, and the pipe residual powder weight and the kinetic energy residual powder weight corresponding to the second grinding rate.
S104. if bean grinding at the second grinding rate is to be started, grinding at the second grinding rate, and sending a stop signal to a motor after the grinding duration.
S105. otherwise, continuing grinding at the first grinding rate, and going back to judging whether to start grinding at the second grinding rate under the current ground powder weight of the weighing sensor so as to continue execution.

Embodiments of the present disclosure provide a bean grinding method and apparatus, an electronic device, and a storage medium. The bean grinding method includes: acquiring a first grinding rate and a total ground powder weight set by a user; determining a grinding duration corresponding to a second grinding rate according to the first grinding rate; the second grinding rate is a preset known grinding rate corresponding to a pipe residual powder weight and a kinetic energy residual powder weight; when a grinding rate of a bean grinding machine reaches the first grinding rate, judging whether to start grinding at the second grinding rate under a current ground powder weight of a weighing sensor according to the first grinding rate, the total ground powder weight, and the pipe residual powder weight and the kinetic energy residual powder weight corresponding to the second grinding rate; if bean grinding at the second grinding rate is to be started, carrying out bean grinding at the second grinding rate, and sending a stop signal to a motor after the grinding duration; otherwise, continuing grinding at the first grinding rate, and going back to judging whether to start grinding at the second grinding rate under the current ground powder weight of the weighing sensor so as to continue execution. In the present disclosure, when the grinding rate of the bean grinding machine reaches the first grinding rate, judging whether to start grinding at the second grinding rate under the current ground powder weight of the weighing sensor; if bean grinding at the second grinding rate is to be started, grinding at the second grinding rate, and sending the stop signal to the motor after the grinding duration; otherwise, continuing to judge whether to start grinding at the second grinding rate. The present disclosure enables the bean grinding machine to grind beans, and the actual ground powder weight of the bean grinding machine is equal to the total ground powder weight required by the user.

The following describes the exemplary steps of an embodiment of the present disclosure.

S101. acquiring a first grinding rate and a total ground powder weight set by a user.

In this embodiment of the present disclosure, the first grinding rate is a grinding rate for the bean grinding machine set by the user. The total ground powder weight is a weight of the powder that needs to be ground by the bean grinding machine set by the user.

Here, the powder ground by the motor of the bean grinding machine after bean grinding first enters a powder collection pipe from one end of the powder collection pipe, then flows out of the other end of the powder collection pipe and falls into a powder container. In addition, a weighing sensor is provided below a powder collection container for weighing the powder in the powder container.

S102. determining a grinding duration corresponding to a second grinding rate according to the first grinding rate.

In this embodiment of the present disclosure, the second grinding rate is a second grinding rate preset by a technician. The pipe residual powder weight refers to a weight of powder that has been ground by the motor but has not yet fallen into the powder container when bean grinding continues at the second grinding rate. The kinetic energy residual powder weight refers to a weight of powder that continues to be ground due to the kinetic energy generated by the current motor speed after the motor is sent a signal to stop bean grinding when bean grinding at the second grinding rate. The grinding duration specifies a duration of bean grinding at the second grinding rate during the current grinding process.

Here, if the pipe residual powder weight and the kinetic energy residual powder weight of the bean grinding machine are known at this time when the stop signal is finally sent to the motor, the final actual ground powder weight of the bean grinding machine can be guaranteed to be equal to the total ground powder weight preset by the user. Therefore, the second grinding rate must be a known grinding rate that already clearly corresponds to the pipe residual powder weight and the kinetic energy residual powder weight.

Specifically, determining a difference between the first grinding rate and the second grinding rate.

In this embodiment of the present disclosure, the second grinding rate is subtracted from the first grinding rate to obtain the difference between the first grinding rate and the second grinding rate.

Specifically, determining the grinding duration according to this difference and the second grinding rate.

In this embodiment of the present disclosure, it takes time from sending a signal to the motor until the motor executes the signal content, so we preset a preset duration in advance. If bean grinding continues at the first grinding rate, a stop signal should be sent to the motor after the preset duration so that final actual ground powder weight of the bean grinding machine equals the total ground powder weight preset by the user. However, in order to send the stop signal to the motor, the pipe residual powder weight and the kinetic energy residual powder weight of the bean grinding machine are known at this time, so bean grinding is carried out at the second grinding rate instead. However, due to the speed difference between the first grinding rate and the second grinding rate, the weight of the powder ground by each grinding rate within the same duration is different. Therefore, it is necessary to calculate the grinding duration required at the second grinding rate to ensure the same weight of powder is ground within the preset duration after switching from the first grinding rate to the second grinding rate. As can be seen from the above, the weight of powder ground by grinding at the first grinding rate for the preset duration is the same as the weight of powder ground by grinding at the second grinding rate for the same grinding duration.

Furthermore, a product of the difference and the preset duration is first calculated to obtain the weight difference between the powder ground corresponding to the first grinding rate and the second grinding rate within the preset duration. The ratio of this product to the second grinding rate is then calculated. This ratio represents the duration required for the bean grinding machine to grind the same weight of powder as the weight difference if bean grinding is carried out at the second grinding rate. Finally, the sum of this ratio and the preset duration is calculated to obtain the duration that the bean grinding machine grinds beans at the second grinding rate.

Optionally, the calculation process of the grinding duration can also be expressed using the following formula:

$$T = ( At\_ 0 ) / V\_ 2 + t\_ 0 ;$$

where, T is the grinding duration, A is the difference between the first grinding rate and the second grinding rate, t_0 is the preset duration, and V_2 is the second grinding rate.

S103. when a grinding rate of a bean grinding machine reaches the first grinding rate, judging whether to start grinding at the second grinding rate under a current ground powder weight of a weighing sensor according to the first grinding rate, the total ground powder weight, and a pipe residual powder weight and a kinetic energy residual powder weight corresponding to the second grinding rate.

It is judged whether to start grinding at the second grinding rate under a current ground powder weight of a weighing sensor by the following steps.

I. determining a target ground powder weight according to the first grinding rate, the total ground powder weight, and the pipe residual powder weight and the kinetic energy residual powder weight.

In this embodiment of the present disclosure, the target ground powder weight represents a value of the weighing sensor when the bean grinding machine starts grinding at the second grinding rate. That is, when the weight of the powder container is equal to the target ground powder weight, the bean grinding machine starts bean grinding at the second grinding rate.

Specifically, the method for determining the target ground powder weight includes: determining an initial ground powder weight after grinding at the first grinding rate for a preset duration; calculating a sum of the initial ground powder weight, the pipe residual powder weight, and the kinetic energy residual powder weight; and subtracting the sum from the total ground powder weight to obtain the target ground powder weight.

In this embodiment of the present disclosure, the initial ground powder weight is determined by multiplying the first grinding rate by the preset duration.

Here, the sum of the initial ground powder weight, the pipe residual powder weight, and the kinetic energy residual powder weight is the sum of the ground powder weight of the bean grinding machine grinding at the second grinding rate for the preset duration, the weight of the powder that has been ground but has not yet fallen into the powder container after the stop signal is sent to the motor, and the weight of the powder that continues to be ground due to the kinetic energy generated by the current motor speed. Subtract the sum from the total ground powder weight to obtain the value of the weighing sensor when the bean grinding machine starts grinding at the second grinding rate.

II. judging whether to start grinding at the second grinding rate by comparing the target ground powder weight with a current ground powder weight.

In this embodiment of the present disclosure, the current ground powder weight is the value of the weighing sensor. The value of the weighing sensor represents the weight of the powder in the powder container.

Specifically, if the target ground powder weight is the same as the current ground powder weight, then starting grinding at the second grinding rate.

S104. if grinding at the second grinding rate is to be started, carrying out grinding at the second grinding rate, and sending a stop signal to a motor after the grinding duration.

S105. otherwise, continuing grinding at the first grinding rate, and going back to judging whether to start grinding at the second grinding rate under the current ground powder weight of the weighing sensor so as to continue execution.

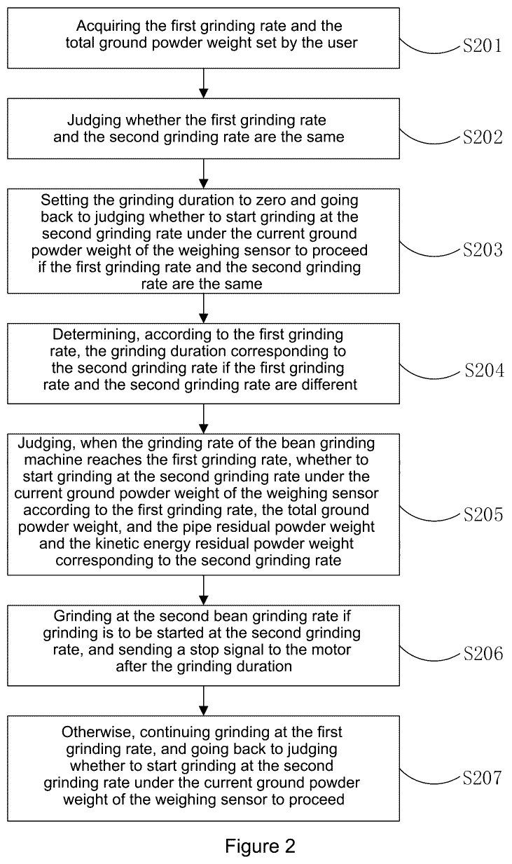

FIG. 2 is a flow chart illustrating a bean grinding method provided an embodiment of the present disclosure. The similarities between steps S201 to S207 and steps S101 to S105 refer to steps S101 to S105, and their descriptions are omitted. The following describes the exemplary steps of the embodiment of the present disclosure.
S201. acquiring the first grinding rate and the total ground powder weight set by the user.
S202. judging whether the first grinding rate and the second grinding rate are the same.
S203. if the first grinding rate and the second grinding rate are the same, setting the grinding duration to zero and going back to judging whether to start grinding at the second grinding rate under the current ground powder weight of the weighing sensor so as to continue execution.

In this embodiment of the present disclosure, if the first grinding rate and the second grinding rate are the same, there is no speed difference between the first grinding rate and the second grinding rate. Therefore, there is no need to consider the duration required to switch from the first grinding rate to the second grinding rate, nor is there any need to calculate the grinding duration for the second grinding rate. The grinding duration is simply set to zero.
S204. if the first grinding rate and the second grinding rate are different, determining the grinding duration corresponding to the second grinding rate according to the first grinding rate.
S205. when the grinding rate of the bean grinding machine reaches the first grinding rate, judging whether to start grinding at the second grinding rate under the current ground powder weight of the weighing sensor according to the first grinding rate, the total ground powder weight, and the pipe residual powder weight and the kinetic energy residual powder weight corresponding to the second grinding rate.
S206. if grinding at the second grinding rate is to be started, carrying out grinding at the second grinding rate, and sending a stop signal to the motor after the grinding duration.
S207. otherwise, continuing grinding at the first grinding rate, and going back to judging whether to start grinding at the second grinding rate under the current ground powder weight of the weighing sensor so as to continue execution.

The embodiment of the present disclosure provides a bean grinding method. The bean grinding method includes: acquiring a first grinding rate and a total ground powder weight set by a user; judging whether the first grinding rate and the second grinding rate are the same; if the first grinding rate and the second grinding rate are the same, setting the grinding duration to zero and going back to judging whether to start grinding at the second grinding rate under the current ground powder weight of the weighing sensor so as to continue execution; if the first grinding rate and the second grinding rate are different, determining the grinding duration corresponding to the second grinding rate according to the first grinding rate; the second grinding rate is a preset known grinding rate that corresponds to the pipe residual powder weight and the kinetic energy residual powder weight; when the grinding rate of the bean grinding machine reaches the first grinding rate, judging whether to start grinding at the second grinding rate under the current ground powder weight of the weighing sensor according to the first grinding rate, the total ground powder weight, and the pipe residual powder weight and the kinetic energy residual powder weight corresponding to the second grinding rate; if grinding at the second grinding rate is to be started, carrying out grinding at the second grinding rate, and sending a stop signal to the motor after the grinding duration; otherwise, continuing grinding at the first grinding rate, and going back to judging whether to start grinding at the second grinding rate under the current ground powder weight of the weighing sensor so as to continue execution. The present disclosure determines different grinding methods by judging whether the first grinding rate and the second grinding rate are the same. The present disclosure enables the bean grinding machine to grind bean, and the actual ground powder weight of the bean grinding machine is equal to the total ground powder weight required by the user.

Based on the same inventive concept, the embodiments of the present disclosure also provide a bean grinding apparatus corresponding to the bean grinding method. Since the principles underlying the device in the embodiments of the present disclosure are similar to those of the bean grinding method described above, the implementation of the device can be referred to as the implementation of the method, and any repetitions will be omitted.

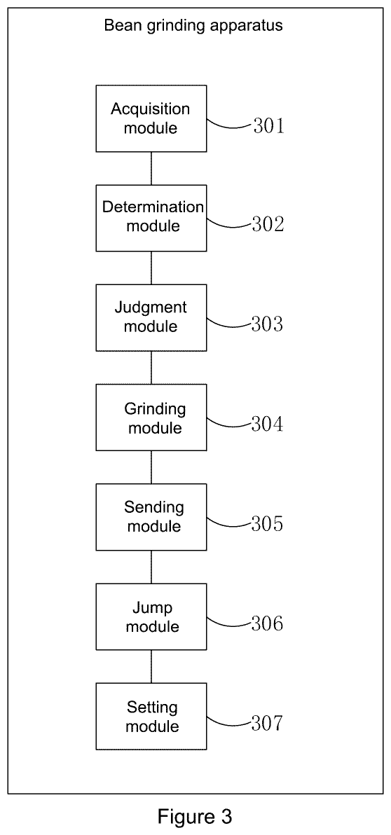

FIG. 3 is a schematic diagram of a bean grinding apparatus provided in the embodiments of the present disclosure. The bean grinding apparatus includes:
an acquisition module 301, configured to acquire a first grinding rate and a total ground powder weight set by a user;
a determination module 302, configured to determine a grinding duration corresponding to a second grinding rate according to the first grinding rate; the second grinding rate is a preset known grinding rate that corresponds to a pipe residual powder weight and a kinetic energy residual powder weight;
a judgment module 303, configured to judge, when a grinding rate of a bean grinding machine reaches the first grinding rate, whether to start grinding at the second grinding rate under a current ground powder weight of a weighing sensor according to the first grinding rate, the total ground powder weight, and the pipe residual powder weight and the kinetic energy residual powder weight corresponding to the second grinding rate;
a grinding module 304, configured to carry out, if grinding at the second grinding rate is to be started, grinding at the second grinding rate;
a sending module 305, configured to send a stop signal to a motor after the grinding duration;
jumping module 306, configured to otherwise continue grinding at the first grinding rate, and going back to judging whether to start grinding at the second grinding rate under the current ground powder weight of the weighing sensor so as to continue execution.

In one possible embodiment, the judgment module 303 is specifically configured to determine a target ground powder weight according to the first grinding rate, the total ground powder weight, and the pipe residual powder weight and the kinetic energy residual powder weight; and determine whether to start grinding at the second grinding rate by comparing the target ground powder weight with the current ground powder weight.

In one possible embodiment, the judgment module 303 is further configured to start grinding at the second grinding rate if the target ground powder weight is the same as the current ground powder weight.

In one possible embodiment, the judgment module 303 is further configured to:
determine the initial ground powder weight after grinding at the first grinding rate for a preset duration;
calculate a sum of the initial ground powder weight, the pipe residual powder weight, and the kinetic energy residual powder weight; and
subtract the sum from the total ground powder weight to obtain the target ground powder weight.

In one possible embodiment, the determination module 302 is specifically configured to determine the difference between the first grinding rate and the second grinding rate; and determine the grinding duration according to the difference and the second grinding rate.

In one possible embodiment, the bean grinding apparatus further includes: a setting module 307.

The judgment module 303 is further configured to determine whether the first grinding rate and the second grinding rate are the same.

The setting module 307 is configured to set the grinding duration to zero if the first grinding rate and the second grinding rate are the same.

The jumping module 306 is further configured to go back to judging whether to start grinding at the second grinding rate under the current ground powder weight of the weighing sensor so as to continue execution.

The jumping module 306 is further configured to, if the first grinding rate and the second grinding rate are different, go back to determining the grinding duration corresponding to the second grinding rate so as to continue execution.

The embodiment of the present disclosure provides a bean grinding apparatus. The bean grinding apparatus includes: an acquisition module 301, configured to obtain a first grinding rate and a total ground powder weight set by a user; a determination module 302, configured to determine a grinding duration corresponding to the second grinding rate according to the first grinding rate; the second grinding rate is a preset known grinding rate that corresponds to a pipe residual powder weight and a kinetic energy residual powder weight; a judgment module 303, configured to judge, when a grinding rate of a bean grinding machine reaches the first grinding rate, whether to start grinding at the second grinding rate under a current ground powder weight of a weighing sensor according to the first grinding rate, the total ground powder weight, and the pipe residual powder weight and the kinetic energy residual powder weight corresponding to the second grinding rate; a grinding module 304, configured to carry out, if grinding at the second grinding rate is to be started, grinding at the second grinding rate; a sending module 305, configured to send a stop signal to a motor after the grinding duration; and jumping module 306, configured to otherwise continue grinding at the first grinding rate, and going back to determine whether to start grinding at the second grinding rate under the current ground powder weight of the weighing sensor so as to continue execution. In the present disclosure, when the grinding rate of the bean grinding machine reaches the first grinding rate, judging whether to start grinding at the second grinding rate under the current ground powder weight of the weighing sensor; if bean grinding at the second grinding rate is to be started, carrying out bean grinding at the second grinding rate and sending the stop signal to the motor after the grinding duration; otherwise continuing to judge whether to start grinding at the second grinding rate. The present disclosure enables the bean grinding machine to grind beans, and the actual ground powder weight of the bean grinding machine is equal to the total ground powder weight required by the user.

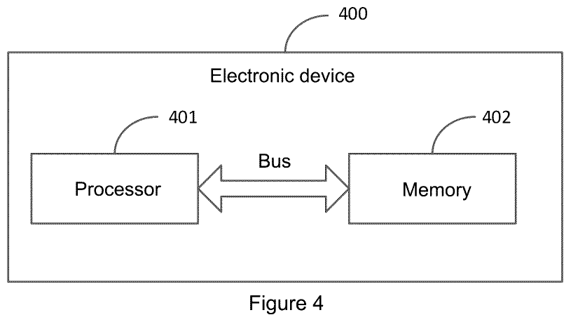

As shown in FIG. 4, an embodiment of the present disclosure provides an electronic device 400 including: a processor 401, a memory 402, and a bus. The memory 402 stores machine-readable instructions executable by the processor 401. When the electronic device is in operation, the processor 401 communicates with the memory 402 via the bus, and the processor 401 executes the machine-readable instructions to perform the steps of the bean grinding method described above.

Specifically, the memory 402 and processor 401 can be general-purpose memories and processors, and are not specifically limited herein. When the processor 401 executes a computer program stored in the memory 402, the bean grinding method described above can be performed.

Corresponding to the bean grinding method described above, an embodiment of the present disclosure also provides a computer-readable storage medium, and the computer program is stored on the computer-readable storage medium. When the computer program is executed by the processor, the steps of the bean grinding method described above are performed.

Those skilled in the art will clearly understand that, for ease and brevity of description, the specific operating procedures of the systems and devices described above can refer to the corresponding procedures in the method embodiments and will not be further described in the present disclosure. In the several embodiments provided by the present disclosure, it should be understood that the disclosed systems, devices, and methods can be implemented in other ways. The device embodiments described above are merely illustrative. For example, the module divisions described represent only one logical functional division; actual implementations may employ different divisions. For example, multiple modules or components may be combined or integrated into another system, or some features may be omitted or not implemented. Furthermore, the couplings or direct couplings or communication connections shown or discussed may be through communication interfaces, or indirect couplings or communication connections between devices or modules, and may be electrical, mechanical, or other.

The modules described as separate components may or may not be physically separate, and the components shown as modules may or may not be physical units, i.e., they may be located in a single location or distributed across multiple network units. Some or all of the units may be selected according to actual needs to achieve the purpose of the solution in this embodiment.

In addition, the functional units in the various embodiments of the present disclosure may be integrated into a single processing unit, each unit may exist physically separately, or two or more units may be integrated into a single unit.

If the functions are implemented as software functional units and sold or used as standalone products, they may be stored in a processor-executable non-volatile computer-readable storage medium. Based on this understanding, the essential technical solution of the present disclosure, or the portion that contributes to the prior art, or the portion of the technical solution, can be embodied in the form of a software product. This computer software product, stored on a storage medium, includes instructions for enabling a computer device (such as a personal computer, server, or network device) to perform all or part of the steps of the information processing method described in each embodiment of the present disclosure. The aforementioned storage medium includes various media capable of storing program code, such as a USB flash drive, a mobile hard drive, ROM, RAM, a magnetic disk, or an optical disk.

The above are merely specific embodiments of the present disclosure, but the scope of protection of the present disclosure is not limited thereto. Any modifications or substitutions that can be readily conceived by a person skilled in the art within the technical scope disclosed in the present disclosure are intended to be covered by the scope of protection of the present disclosure. Therefore, the scope of protection of the present disclosure shall be based on the scope of protection of the claims.

1. A bean grinding method, comprising steps of:
acquiring a first grinding rate and a total ground powder weight set by a user;
determining, according to the first grinding rate, a grinding duration corresponding to a second grinding rate, wherein the second grinding rate is a preset known grinding rate corresponding to a pipe residual powder weight and a kinetic energy residual powder weight;
judging, when a grinding rate of a bean grinding machine reaches the first grinding rate, whether to start grinding at the second grinding rate under a current ground powder weight of a weighing sensor according to the first grinding rate, the total ground powder weight, and the pipe residual powder weight and the kinetic energy residual powder weight corresponding to the second grinding rate; and
grinding at the second grinding rate if grinding is to be started at the second grinding rate, and sending a stop signal to a motor after the grinding duration;
otherwise, continuing grinding at the first grinding rate, and going back to step of judging whether to start grinding at the second grinding rate under a current ground powder weight of a weighing sensor to proceed.

2. The bean grinding method according to claim 1, wherein the step of judging whether to start grinding at the second grinding rate under a current ground powder weight of a weighing sensor comprises steps of:
determining a target ground powder weight according to the first grinding rate, the total ground powder weight, and the pipe residual powder weight and the kinetic energy residual powder weight; and
judging whether to start grinding at the second grinding rate by comparing the target ground powder weight with a current ground powder weight.

3. The bean grinding method according to claim 2, wherein the step of judging whether to start grinding at the second grinding rate comprises:
starting grinding at the second grinding rate if the target ground powder weight is the same as the current ground powder weight.

4. The bean grinding method according to claim 2, wherein the step of determining a target ground powder weight comprises:
determining an initial ground powder weight after grinding at the first grinding rate for a preset duration;
calculating a sum of the initial ground powder weight, the pipe residual powder weight, and the kinetic energy residual powder weight; and
subtracting the sum from the total ground powder weight to obtain the target ground powder weight.

5. The bean grinding method according to claim 1, wherein the step of determining a grinding duration corresponding to a second grinding rate comprises:
determining a difference between the first grinding rate and the second grinding rate; and
determining the grinding duration according to the difference and the second grinding rate.

6. The bean grinding method according to claim 1, wherein before the step of judging a grinding duration corresponding to a second grinding rate, the bean grinding method further comprises steps of:
judging whether the first grinding rate and the second grinding rate are the same;
setting the grinding duration to zero and going back to the step of judging whether to start grinding at the second grinding rate under a current ground powder weight of a weighing sensor to proceed, if the first grinding rate and the second grinding rate are the same; and
going back to the step of determining a grinding duration corresponding to a second grinding rate to proceed, if the first grinding rate and the second grinding rate are different.

7-8. (canceled)

9. An electronic device, comprising: a processor, a storage medium, and a bus, wherein the storage medium stores machine-readable instructions executable by the processor; and when the electronic device is in operation, the processor and the storage medium communicate via the bus, and the processor executes the machine-readable instructions to perform the steps of the bean grinding method according to claim 1.

10. A computer-readable storage medium, storing a computer program thereon, wherein the computer program, when executed by a processor, performs the steps of the bean grinding method according to claim 1.

11. The electronic device according to claim 9, wherein the step of judging whether to start grinding at the second grinding rate under a current ground powder weight of a weighing sensor comprises steps of:
determining a target ground powder weight according to the first grinding rate, the total ground powder weight, and the pipe residual powder weight and the kinetic energy residual powder weight; and
judging whether to start grinding at the second grinding rate by comparing the target ground powder weight with a current ground powder weight.

12. The electronic device according to claim 11, wherein the step of judging whether to start grinding at the second grinding rate comprises:
starting grinding at the second grinding rate if the target ground powder weight is the same as the current ground powder weight.

13. The electronic device according to claim 11, wherein the step of determining a target ground powder weight comprises:
determining an initial ground powder weight after grinding at the first grinding rate for a preset duration;
calculating a sum of the initial ground powder weight, the pipe residual powder weight, and the kinetic energy residual powder weight; and
subtracting the sum from the total ground powder weight to obtain the target ground powder weight.

14. The electronic device according to claim 9, wherein the step of determining a grinding duration corresponding to a second grinding rate comprises:
determining a difference between the first grinding rate and the second grinding rate; and
determining the grinding duration according to the difference and the second grinding rate.

15. The electronic device according to claim 9, wherein before the step of judging a grinding duration corresponding to a second grinding rate, the bean grinding method further comprises steps of:
judging whether the first grinding rate and the second grinding rate are the same;
setting the grinding duration to zero and going back to the step of judging whether to start grinding at the second grinding rate under a current ground powder weight of a weighing sensor to proceed, if the first grinding rate and the second grinding rate are the same; and
going back to the step of determining a grinding duration corresponding to a second grinding rate to proceed, if the first grinding rate and the second grinding rate are different.

16. The computer-readable storage medium according to claim 10, wherein the step of judging whether to start grinding at the second grinding rate under a current ground powder weight of a weighing sensor comprises steps of:
determining a target ground powder weight according to the first grinding rate, the total ground powder weight, and the pipe residual powder weight and the kinetic energy residual powder weight; and
judging whether to start grinding at the second grinding rate by comparing the target ground powder weight with a current ground powder weight.

17. The computer-readable storage medium according to claim 16, wherein the step of judging whether to start grinding at the second grinding rate comprises:
starting grinding at the second grinding rate if the target ground powder weight is the same as the current ground powder weight.

18. The computer-readable storage medium according to claim 16, wherein the step of determining a target ground powder weight comprises:
determining an initial ground powder weight after grinding at the first grinding rate for a preset duration;
calculating a sum of the initial ground powder weight, the pipe residual powder weight, and the kinetic energy residual powder weight; and
subtracting the sum from the total ground powder weight to obtain the target ground powder weight.

19. The computer-readable storage medium according to claim 10, wherein the step of determining a grinding duration corresponding to a second grinding rate comprises:
determining a difference between the first grinding rate and the second grinding rate; and
determining the grinding duration according to the difference and the second grinding rate.

20. The computer-readable storage medium according to claim 10, wherein before the step of judging a grinding duration corresponding to a second grinding rate, the bean grinding method further comprises steps of:
judging whether the first grinding rate and the second grinding rate are the same;
setting the grinding duration to zero and going back to the step of judging whether to start grinding at the second grinding rate under a current ground powder weight of a weighing sensor to proceed, if the first grinding rate and the second grinding rate are the same; and
going back to the step of determining a grinding duration corresponding to a second grinding rate to proceed, if the first grinding rate and the second grinding rate are different.
